(19) United States
(12) Patent Application Publication
(10) Pub. No.: US 2026/0305877 A1
(43) Pub. Date: Oct. 8, 2026

(54) COOKWARE HANDLES

(71) Applicant: Oakthrift Corporation Ltd., Tolleshunt Knights (GB)

(72) Inventor: Lloyd Freedman, Tolleshunt Knights (GB)

(73) Assignee: Oakthrift Corporation Ltd., Tolleshunt Knights (GB)

(21) Appl. No.: 19/461,940

(22) Filed: Jan. 28, 2026

(30) Foreign Application Priority Data
Jan. 30, 2025 (GB) 2501388.9
Feb. 26, 2025 (GB) 2502770.7

(51) Int. Cl. A47J 45/06

(52) U.S. Cl. CPC A47J 45/061

(57) ABSTRACT

An item of cookware comprises a main body and two opposing handles wherein each handle has a first portion configured to extend substantially laterally from the main body and an elongate second portion extending from an upper side of the first portion. The first portion has an elongate section with an underside that is configured to rest on the hand of a user when the handle is in use. The second portion is configured to be gripped by the hand of a user when the handle is in use.

### SUMMARY OF THE INVENTION

The present invention relates to improvements in cookware handles.

Cooking pots are a common household utensil, often with the handles oriented laterally with respect to the base of the pot. Such pots are predominantly used by holding the handles with four fingers underneath the handle and the thumb on top. This type of handle is prone to user accident due to unnatural and uncomfortable gripping, especially in those who have weaker arm, wrist and finger strength.

Some pot handles are now U-shaped in order for the user to wrap their fingers through the handle, offering greater support. This is an improvement in the solid lateral projecting handles however many users still find the equipment difficult to use due to the unnatural gripping position.

The present invention seeks to improve upon the prior art to make the process of placing and removing pots from the oven easier. The present invention also seeks to improve the process of lifting the pots and pouring therefrom.

According to a first aspect of the present invention there is provided an item of cookware comprising a main body and two opposing handles, wherein each handle comprises:

a first portion configured to extend substantially laterally from the main body;

the first portion comprising an elongate section having an underside that is configured to rest on the hand of a user when the handle is in use;

an elongate second portion extending from an upperside of the first portion, the second portion being configured to be gripped by the hand of a user when the handle is in use.

Beneficially an item of cookware constructed in accordance with the present invention has three modes of use.

In a first mode of use a user may hold the handle in a conventional manner by resting the elongate sections of the first portion on their hands.

In a second mode of use a user may grasp the upright elongate second portions.

In a third mode of use a user may rest the elongate section of a first handle on a first hand and grasp the upright elongate second portion of the other handle with a second hand. Beneficially as both handles comprise an elongate section and an elongate second portion a user may choose whether to grasp the upright portion with their left hand or with their right hand.

For some users this can be especially useful when pouring contents out of the item of cookware.

In some embodiments the elongate second portion is contoured to aid the grip of a user.

In some embodiments the elongate second portion comprises one or more ribs to aid the grip of a user.

In some embodiments the elongate second portion is hollow or comprises apertures.

Advantageously by making the second portion hollow or by providing it with apertures the second portion does not significantly add to the weight of a cookware item.

In some embodiments the second portion is substantially pyriform in shape, or is substantially bulbous in shape, or is substantially hook-shaped.

In some embodiments the elongate section of the first portion extends substantially parallel to an edge of the main body of the item of cookware.

In some embodiments the elongate section of the first portion comprises a substantially concave underside.

In some embodiments the elongate section of the first portion comprises a substantially convex upperside.

In some embodiments the first portion is substantially U-shaped and comprises means to attach to the main body at each of its free ends.

In some embodiments the elongate second portion extends towards the main body at an angle to the vertical when the main body is on a flat surface.

In some embodiments the elongate second portion extends towards the main body at an angle to the vertical of between 5 and 30 degrees, and an angle to the vertical of between 10 and 20 degrees or at an angle to the vertical of between 12 to 15 degrees.

In some embodiments an item of cookware is a skillet, a pan, a wok, a saucepan, a pot, a braiser, a French oven or a Dutch oven.

According to a second aspect of the present invention there is provided a method of cooking comprising the step of providing an item of cookware made in accordance with the present invention.

### BRIEF DESCRIPTION OF THE DRAWINGS

In order that the present invention may be more fully understood a specific embodiment will now be described by way of example with reference to the accompanying schematic drawings, of which:

FIG. 1 is a side view of a cooking pot with two handles made in accordance with the present invention;

FIG. 2 is a perspective view of the cooking pot of FIG. 1;

FIG. 3 a plan view of the cooking pot of FIG. 1; and

FIG. 4 is a lower perspective view of the cooking pot of FIG. 1.

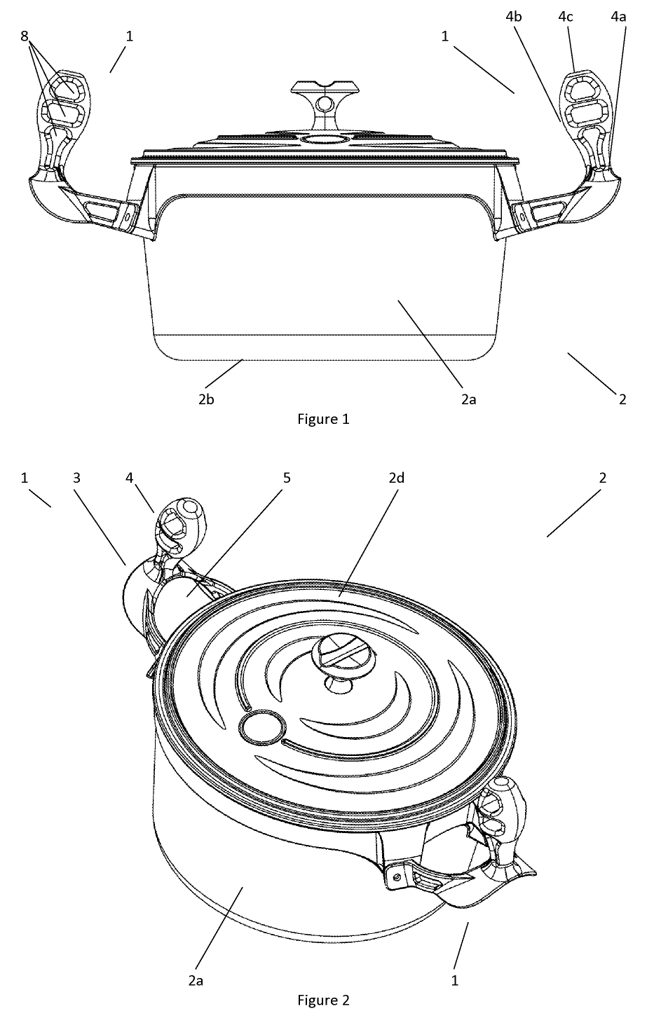

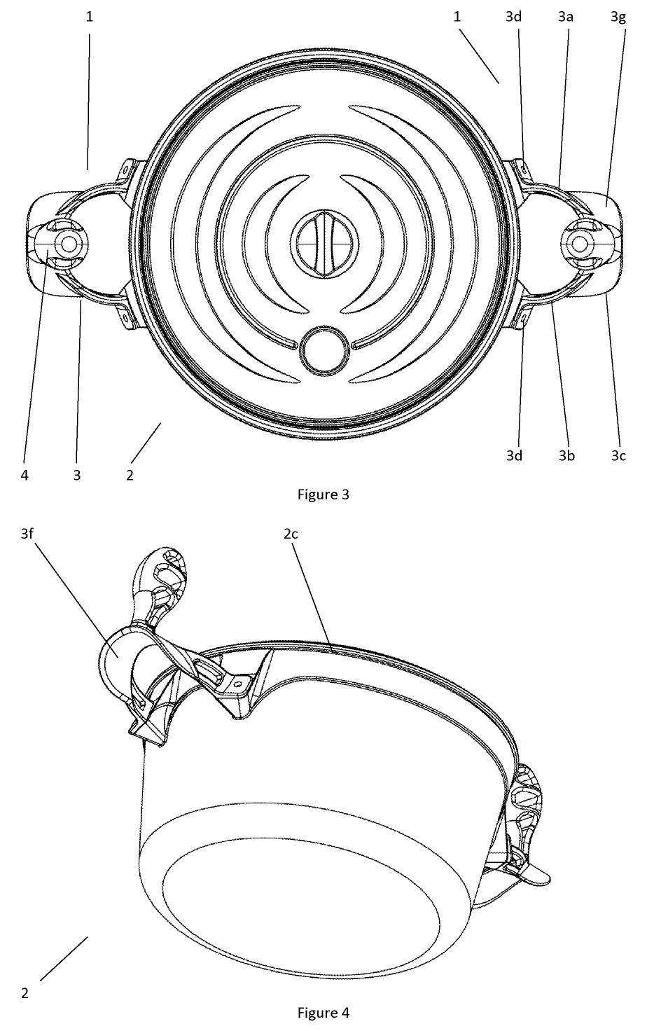

### DETAILED DESCRIPTION OF THE INVENTION

Referring to the drawings, a handle 1 of a cooking pot 2 comprises a substantially laterally extending first portion 3 and an upwardly extending second portion 4.

Cooking pot 2 comprises two handles 1 and a main body 2a.

In the present embodiment handles 1 are substantially permanently attached to main body 2a by any suitable means such as riveting, welding or screws.

Main body 2a comprises a substantially planar base 2b and a substantially planar rim 2c defining a substantially circular opening to the interior of pot 2. Pot 2 comprises a lid 2d.

Laterally extending first portion 3 is substantially U-shaped and comprise first and second arms 3a, 3b and intermediate elongate section 3c.

First and second arms 3a, 3b comprise at their free ends means to attach to main body 2a of cooking pot 2 in the form of apertures 3d for screwing or riveting handle 1 thereto.

Elongate section 3c of first portion 3 is substantially parallel to a peripheral edge of main body 2b.

Elongate section 3c is in the form of an arcuate band such that it comprises a substantially concave underside 3f and a substantially convex upperside 3g.

Together main body 2b and first portion 3 define a substantially semi-circular opening 5.

Elongate second portion 4 extends from upperside 3g of first portion 3 at its convex maximum. Elongate second portion is attached to upperside 3g at its base 4a.

Elongate second portion 4 is substantially pyriform in shape, tapering from narrower base 4a to a wider upper portion 4b, which then tapers to a narrower free end 4c

Second portion 4 comprises three apertures 8 each of different shape and size. Apertures 8 are provided so as to reduce the weight of handle 1 without compromising structural rigidity.

When main body 2a of pot 2 rests upon a substantially horizontal surface second portion 4 of handle 1 is angled to the vertical at an angle of around 12 degrees. Thus, handle 1 is angled to the substantially planar base 2b and substantially planar rim 2c of pot 2 at an angle of around 78 degrees.

Turning to cooking pot 2 in use when a user wishes to pickup pot 2 they have three options:
i) positioning respective hands under elongate sections 3c of each handle 1;
ii) gripping each of second portions 4 with a respective hand;
iii) gripping second portion 4 of a first handle 1 with a first hand, and positioning a second hand under elongate section 3c of a second handle 1. Beneficially, as both handles comprise an elongate section 3c and a second portion 4 a user may choose to use which of their hands holds an elongate section 3c and which of their hands holds a second portion 4 without reorientating pot 2.

Option i) is a mode of use available with conventional cooking pots.

Options ii) and iii) are modes of use possible only with handles made in accordance with the present invention that can assist a user with lifting and pouring pot 2.

User with weak fingers and/or limited ranges of motion in their hands and arms can find gripping second portions 4 to be particularly beneficial as second portions 4 are each angled towards main body 2a of pot 2.

Thus, as handles 1 of pot 2 are diametrically opposed on sides of pot 2, second portions 4 of handles 1 are angled towards each other.

As such, when a user lifts pot 2 by gripping each of second portions 4 with a respective hand they are able to apply an opposing force with their arms by pulling on second portions 4 to maintain a good grip on pot 2. This grip is enhanced as second portions 4 are pyriform in shape such that they effectively hook over the hands of a user.

In the present embodiment both main body 2a and handles 1 are formed of stainless steel, but any suitable materials could of course be used.

In the present embodiment both elongate section 3c of first portion 3 and elongate second portion 4 are sized so as to accommodate the width of a human hand and are each around 12cm in length. It is anticipated that in most embodiments section 3c and second portion 4 would be in the range of 8cm to 16cm in length or 10cm to 14cm in length.

In this specification an apparatus/method/product "comprising" certain features is intended to be interpreted as meaning that it includes those features, but that it does not exclude the presence of other features.

Many variations are possible without departing from the scope of the present invention as defined in the appended claims.

1. An item of cookware comprising a main body and two opposing handles, wherein each handle comprises:
a first portion configured to extend substantially laterally from the main body;
the first portion comprising an elongate section having an underside that is configured to rest on the hand of a user when the handle is in use;
an elongate second portion extending from an upper side of the first portion, the second portion being configured to be gripped by the hand of a user when the handle is in use.

2. The item of cookware of claim 1 wherein the elongate second portion is contoured to aid the grip of a user.

3. The item of cookware of claim 1 wherein the elongate second portion comprises one or more ribs to aid the grip of a user.

4. The item of cookware of claim 1 wherein the elongate second portion is hollow or comprises apertures.

5. The item of cookware of claim 1 wherein the elongate second portion is substantially pyriform in shape, or is substantially bulbous in shape, or is substantially hook-shaped.

6. The item of cookware of claim 1 wherein the elongate section of the first portion extends substantially parallel to an edge of the main body of the item of cookware.

7. The item of cookware of claim 1 wherein the elongate section of the first portion comprises a substantially concave underside.

8. The item of cookware of claim 1 wherein the elongate section of the first portion comprises a substantially convex upperside.

9. The item of cookware of claim 1 wherein the first portion is substantially U-shaped and comprises means to attach to the main body at each of its free ends.

10. The item of cookware of claim 1 wherein the elongate second portion extends towards the main body at an angle to the vertical when the main body is on a flat surface.

11. The item of cookware of claim 10 wherein the elongate second portion extends towards the main body at an angle to the vertical of between 5 and 30 degrees, and an angle to the vertical of between 10 and 20 degrees or at an angle to the vertical of between 12 to 15 degrees.

12. The item of cookware of claim 1 wherein the item of cookware is a skillet, a pan, a wok, a saucepan, a pot, a braiser, a French oven or a Dutch oven.

13. A method of cooking comprising providing an item of cookware made in accordance with claim 1.
